(19) United States
(12) Patent Application Publication
(10) Pub. No.: US 2002/0149824 A1
(43) Pub. Date: Oct. 17, 2002

(54) Synchronization of an optical pulse stream with an electrical signal

(76) Inventors: Yves Beaulieu, Gatineau (CA); Edward Frlan, Kanata (CA)

Correspondence Address: Shapiro Cohen, P.O. Box 3440, Station D, Ottawa, ON, K1P 6P1, CA

(21) Appl. No.: 09/793,530

(22) Filed: Feb. 27, 2001

(51) Int. Cl. H04B 10/00; H04B 10/04

(52) U.S. Cl. 359/158; 359/184

(57) ABSTRACT

In accordance with the present invention, the degree of timing misalignment between the data and clock paths in a RZ (return-to-zero) transmitter can be determined by converting a fraction of the optical output into the electrical domain with an ultra fast non-linear device, thereby squaring the optical peak power to provide a signal for controlling a phase change in the carrier. Using the same invention, the degree of timing misalignment between incoming optical pulses and an electronic signal fed to a modulator for demultiplexing can also be monitored and controlled in an optical time-division demultiplexing (OTDD) receiver.

### FIELD OF THE INVENTION

This invention relates to synchronization of an optical pulse stream and an electrical signal, such as data in a return-to-zero (RZ) optical transmission system or a simple digital sequence in an optical time-division demultiplexing (OTDD) receiver.

### BACKGROUND TO THE INVENTION

The return-to-zero RZ format is generated in two stages as shown in FIG. 1. In one stage, a carrier is generated by a continuous wave (CW) laser 10 and a pulse generator 20. The carrier consists of a stream of optical pulses shorter than a bit slot and is produced using a clock signal. In another stage, a physical variable is modulated using a data modulator 30 to encode the data on the optical carrier. In all return-to-zero optical transmitters, including optical time domain multiplexing (OTDM) transmitters, the degree of misalignment between the data and clock paths varies with temperature and aging. With increasing bit rates and decreasing bit time slots, the timing variations can severely limit the transmitter performance.

In an optical time-division demultiplexing (OTDD) receiver, a similar timing problem occurs as shown in FIG. 2. A series of optical pulses (data) at a very high data rate arrives at a receiver 35. A splitter is used to generate two (or more) copies of the incoming optical pulse stream. Assuming a 1 to 2 splitting, two modulators 40, 50, generating simple 101010 sequences from a clock signal at half the data rate are used to isolate even and odd bits for detection width slower electronics. Again, the electronic signals 80 that feed the modulators must be synchronized with the incoming pulse stream.

Several prior art techniques have been tried to overcome this problem in RZ transmitters. One approach consists of minimizing the misalignment at the start of life of the transmitter, and permanently fixing the delay between the clock and data paths. This scheme is currently used in submarine RZ optical systems. However, timing budgets indicate that this set-and-forget approach becomes impractical for higher bit rates—for example, in ten gigabits per second RZ transmitters—as timing misalignments due to temperature variations and aging occupy a larger portion of the bit slot, severely degrading the transmitter performance.

Another approach involves temperature monitoring. In principle, the effects due to temperature variations could be partially compensated by calibrating at start of life the required delay for the operating temperature range, and measuring the temperature during the normal operation. However, this scheme would not provide any compensation for the effects of aging.

A third scheme involves measuring the average optical power using a photodetector. However, investigations have indicated that this approach cannot provide an accurate measurement of misalignment, especially for non-50% duty cycle data modulation.

A further proposal is to build into the optical transmitter an on-board receiver. Such a receiver could be built onto the transmitter board to measure the misalignment. While this solution should provide excellent performance, it is not desirable due to its complexity, high cost and high amount of space occupied by the receiver.

### SUMMARY OF THE INVENTION

This invention provides means to synchronize the optical pulse stream (clock path) with the electrical data signal (data path). The present invention solves the alignment problem by providing a means to monitor and minimize the degree of misalignment in a control loop architecture.

In accordance with the present invention, the degree of timing misalignment between the data and clock paths in a RZ (return-to-zero) transmitter or in an OTDD receiver can be determined by converting a fraction of the optical output into the electrical domain with an ultrafast non-linear device, which provides a signal for controlling a phase change in the carrier. While the use of non-linear devices that provide an output proportional to the square of the input will be discussed in this application, other non-linear devices could also be used.

In a first aspect the present invention provides a method of synchronizing an optical pulse stream with an electrical data gate. This method comprises converting a fraction of said optical pulse stream to an electrical signal, measuring the average peak power of the electrical signal, and adjusting the phase of the optical pulse stream to maximize the average peak power of said electrical signal.

In a second aspect the present invention provides a system for synchronizing the phase of an optical output pulse stream with a data stream modulating the pulse stream. The system comprises a pulse generator means to generate a pulse, optical modulator means for modulating the output pulse stream with the pulse generator means receiving an optical signal, optical tap means for tapping and diverting a portion of the output pulse stream, transformer means for transforming the portion of the output pulse stream into an electrical signal, power detection means to detect a average power of said electrical signal, phase adjust means for adjusting a phase of said output pulse stream generated by said pulse generator means, and control means for controlling said phase adjust means based on an average peak power detected by said power detection means. The pulse generator means produces the output pulse stream while the optical modulator receives the output pulse stream and the transformer means receives the portion of the pulse stream.

### BRIEF DESCRIPTION OF DRAWINGS

A better understanding of the invention may be obtained by reading the detailed description of the invention below, in conjunction with the following drawings, in which:

FIG. 1 is a block diagram of a return to zero transmitter according to the prior art;

FIG. 2 is a block diagram of an optical time division demultiplexing (OTDD) receiver according to the prior art;

FIG. 3 illustrates the best case scenario for synchronization between an optical pulse stream and an electrical data gate for long data gate rise and fall times;

FIG. 4 illustrates the worst case scenario for synchronization between an optical pulse stream and an electrical data gate for long data gate rise and fall times;

FIG. 5 illustrates the best care scenario for synchronization between an optical pulse stream and an electrical data gate for short data gate rise and fall times;

FIG. 6 illustrate the worst case scenario for synchronization between an optical pulse stream and an electrical data gate for short data gate rise and fall times;

FIG. 7 is a block diagram of the synchronization system according to an embodiment of the invention;

FIG. 8 illustrates the relationship between the signals Vₚᵤₗₛₑ and Vₚᵤₗₛₑ as used in an embodiment of the invention;

FIG. 9 is a flowchart detailing the steps executed by the microcontroller illustrated in FIG. 7; and

FIG. 10 illustrates error signal generation in the presence of dithering as used in one embodiment of the invention.

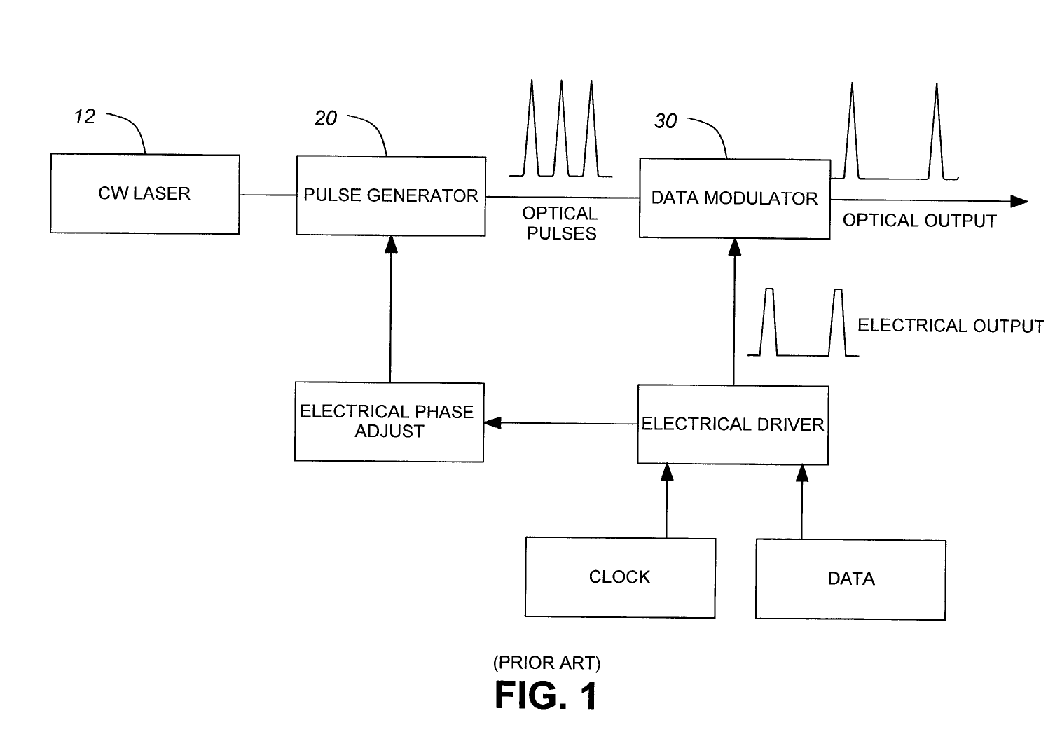

### DETAILED DESCRIPTION

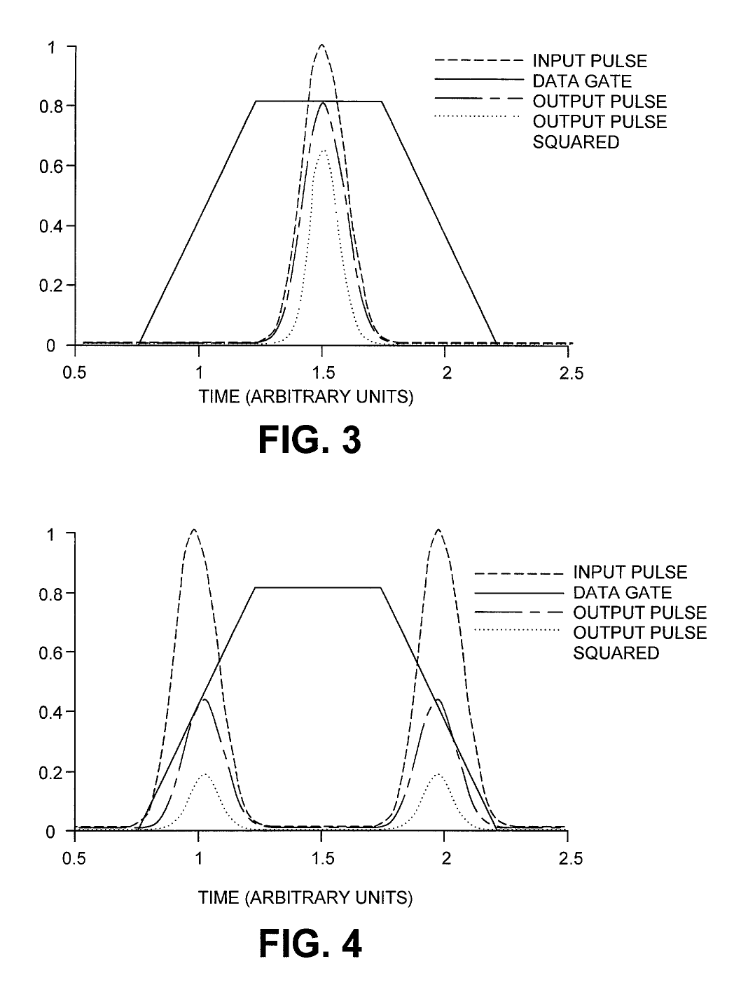

The idea behind the invention can be understood from a limitation of a simple optical average power measurement in the case of a 50% duty cycle and data gates having relatively long rise and fall times. For perfect synchronization between the optical pulse and the electrical data, each bit slot includes one pulse (see FIG. 3). In the worst-case of loss of synchronization, each bit slot is populated by two pulses located at the bit edges (see FIG. 4). Since these pulses overlap with the gate near its 50% value, the average power inside each bit slot is about the same as in the ideal synchronization case, thus failing to give an indicator as to the lack of synchronization. However, peak power is about 50% lower since the number of pulses inside each bit slot is doubled for the worst-case synchronization error.

Squaring the Optical Power

A signal proportional to optical peak power can be obtained by squaring the optical power before taking the average. As an example, consider a Gaussian pulse shape given by

$$y = A exp ( \frac{- 4 ln ( 2 ) {( x - {x}_{0} )}^{2}}{{σ}_{fw h m}^{2}} )$$

The average optical power is given by

$${y}_{ave} = {\int }_{- ∞}^{∞} A exp ( \frac{- 4 ln ( 2 ) {( x - {x}_{0} )}^{2}}{{σ}_{fw h m}^{2}} ) ⅆ x$$

The average of the square of the optical power is

$${( {y}^{2} )}_{ave} = {\int }_{- ∞}^{∞} {( A exp ( \frac{- 4 ln ( 2 ) {( x - {x}_{0} )}^{2}}{{σ}_{fw h m}^{2}} ) )}^{2} ⅆ x = {\int }_{- ∞}^{∞} ( {A}^{2} exp ( \frac{- 8 ln ( 2 ) {( x - {x}_{0} )}^{2}}{{σ}_{fw h m}^{2}} ) ) ⅆ x {\int }_{- ∞}^{∞} exp ( - a {x}^{2} ) ⅆ x = \sqrt{\frac{π}{a}} ,$$

Since

We can write

$${( {y}^{2} )}_{ave} = \frac{A}{\sqrt{2}} {\int }_{- ∞}^{∞} ( A exp ( \frac{- 4 ln ( 2 ) {( x - {x}_{0} )}^{2}}{{σ}_{fw h m}^{2}} ) ) ⅆ x = \frac{A}{\sqrt{2}} {y}_{a v e}$$

Therefore, averaging the square of the optical power gives a signal proportional to the product of the peak optical power (A) and the average optical power (yₐᵥₑ). In the case where the average optical power can be considered a constant, we obtain the desired linear relationship between square of the optical power and peak optical power. This conclusion is valid for other pulse shapes, but the proportionality factor differs slightly. As an example it is about 0.7 for a Gaussian pulse shape, but it is closer to 0.63 for a hyperbolic secant. The effect of squaring can be seen in FIG. 3. For the sake of simplicity, we assume that

1) the pulses have an optical peak power of 1 (arbitrary units),

2) the data gates have no insertion losses at their maximum throughput and

3) the data sequence is a simple series of 101010 . . .

In the best-case synchronization, a single pulse is present in the bit slot, and squaring the optical power produces an output of 1²=1. For the worst-case synchronization (FIG. 4), two pulses are present in the bit, and squaring the optical power generates an output approximately equal to (½)²⁺(½)²=0.5, in agreement with the simple peak power prediction.

Low-pass Filtering

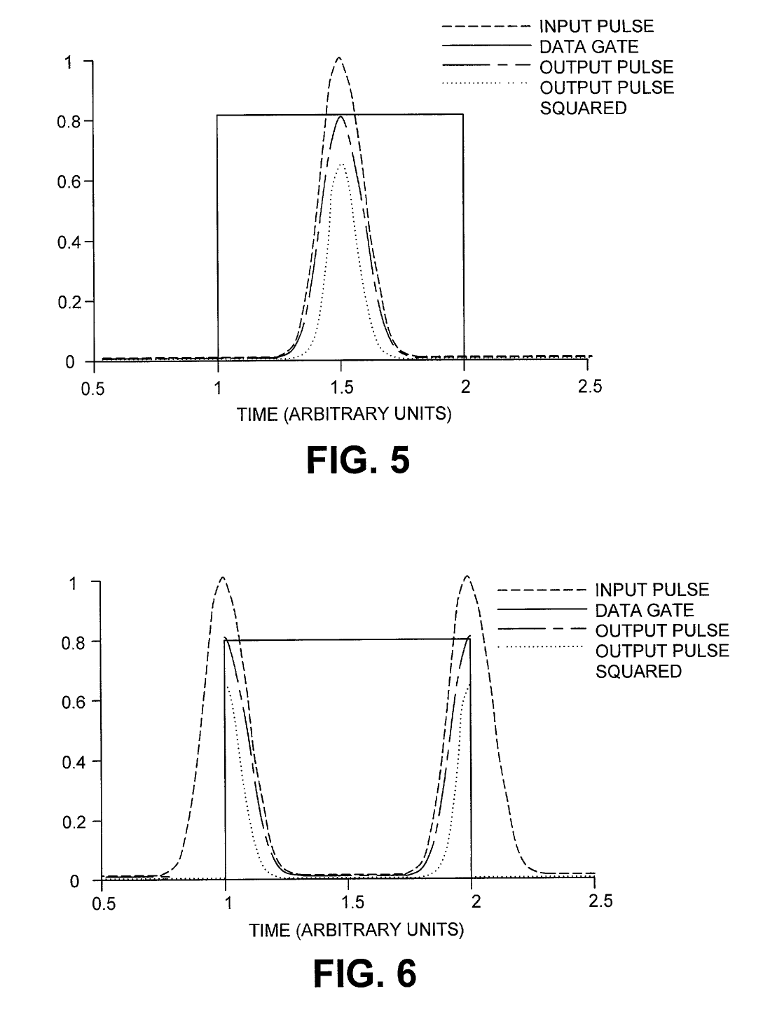

A limitation of the simple squaring approach can be observed in the case of very short rise and fall times, as shown in FIG. 5. In this case, peak optical power is almost independent of synchronization, as variations in pulse widths balance out the variation in the effective number of pulses per bit slot. Instead of decreasing the peak power of each pulses in the worst-case synchronization (FIG. 6), the gate merely cuts the pulse in two half-pulses, maintaining their peak power. In this case, a perfect squaring scheme would generate an output approximately equal to (½)²+(½)(1)²=1 for the worst-case synchronization, the value also predicted for the best-case synchronization.

This limitation for the very short rise and fall times can be corrected by appropriate low-pass filtering. In the worst-case synchronization (FIG. 6), the generated pulses will have a highly asymmetric shape, indicating a larger energy content in the high frequencies than for the best-case synchronization. Removing the high-frequencies before squaring will lead to a smaller output for the worst-case synchronization case and therefore restores an error signal. Using low-pass filtering for long rise and fall times is also beneficial as it enhances discrimination between best-case and worst-case synchronization.

High-pass Filtering

Coupled with low-pass filtering, the simple squaring approach produces strong error signals for data sequences consisting of single 1s. However, for actual data sequences that include long sequences of 1s, the difference in the squaring device output between best-case and worst-case synchronization becomes smaller, since only pulses near the gate ends contribute to the signal. This problem can be solved using a simple high-pass filter that removes the low-frequency content and hence lowers the contribution from the long series of 1s.

Besides improving the relative signal strength, the high-pass filtering provides a much better accuracy, especially for duty cycles larger than 50%. Without filtering, the squaring approach, which is proportional to the peak power and average power, can be dominated for large duty cycles by the average power variation with synchronization. With high-pass filtering, the peak power component dominates and the squaring approach yields an accurate signal for synchronization.

Implementing the squaring function could, in principle, be done in the optical domain using a nonlinear waveguide, such as surface-emitting second-harmonic generation waveguides. However, the current low efficiency of these devices would require an optical amplifier for practical applications.

Squaring the optical output in the electrical domain using a fast photodetector and fast electronics should provide a more accurate error signal, as proper low-pass and high-pass filtering can be implemented between the fast detector and the electrical squaring device. In one aspect, a fast photodetector, such as a PIN photodiode and a trans-impedance amplifier followed by amplification feeds a signal to an electrical power detector such as a microwave diode detector, which behaves according to the square law and, therefore, provides the necessary non-linear function. For low RF powers, coaxial GaAs microwave detectors that have flat frequency responses up to 50 GHz are commercially available. They operate according to a square law for power up to −10 dBm with a sensitivity larger than 0.4 mV/μW. Use of such a device allows optimum alignment to be detected when the electrical power reaches its maximum value. As previously mentioned, electrical filtering between the PIN photodiode and the electrical power detector can be used for enhanced accuracy of the misalignment measurement. Once the degree of misalignment has been measured, it can be minimized by adjusting a variable phase delay block.

A further enhancement of the approach consists in applying a small dither to the relative phase between the optical pulse stream and the data gates and measuring a signal at the dither frequency using a phase-sensitive lock-in technique. This technique enhances the signal-to-noise ratio by effectively filtering out the noise occurring outside of the dither bandwidth. Without dither, the optimum synchronization occurs at the RF power maximum. In the presence of dither, the error-signal generated corresponds to the derivative of the RF power, which provides the additional benefit of locking to a zero value.

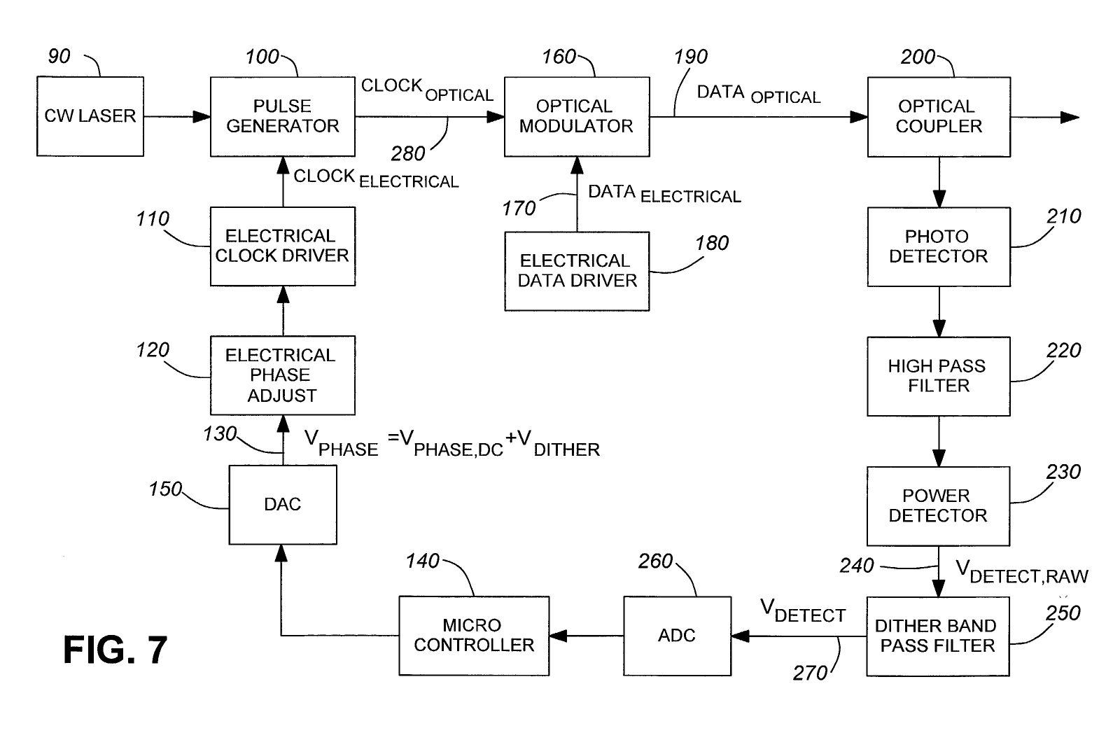

An embodiment of the invention is illustrated in the block diagram of FIG. 7.

Optical pulses are generated using a CW (continuous wave) laser source 90 and an optical pulse generator 100. The pulse generator is clocked by an electrical clock driver 110 whose phase can be adjusted via the electrical phase adjust 120. The Vₚₕₐₛₑ signal 130 is adjusted continually using a Microcontroller 140 in order that any short term and long term drift between the electrical data and optical pulse stream can be compensated. The Microcontroller writes the Vₚₕₐₛₑ signal 130 into a DAC 150 which feeds the electrical phase adjust 120. More details on the firmware software are given below. The optical modulator 160 is gated by the electrical data driver signal 170 from the electrical data driver 180 and thereby generates the optical data stream, Data_{optical} 190. An optical coupler 200 is used to tap off a small portion of the transmit power which is required for the power detection. The optical, tapped transmit signal is transformed back into the electrical domain using a photodetector 210. In this implementation, a dedicated lowpass filter is not shown since sufficient lowpass filtering is obtained from the photodetector's inherent lowpass frequency filtering. However, depending upon the frequency response of the photodetector, a dedicated lowpass filter can be utilized if required. The output signal from the photodetector is then highpass filtered using High pass filter 220 and sent to the power detector block 230, which outputs a raw detected power given by V_{detect,raw} 240. Appropriate bandpass filtering is performed by the dither bandpass filter 250 in order to filter out noise so as to increase sensitivity at the input to the ADC block 260. The filtered V_{detect,raw} signal is termed V_{detect} 270. The Microcontroller 140 reads in the ADC output and performs its firmware routine in order to optimize the V_{phase,DC} setting.

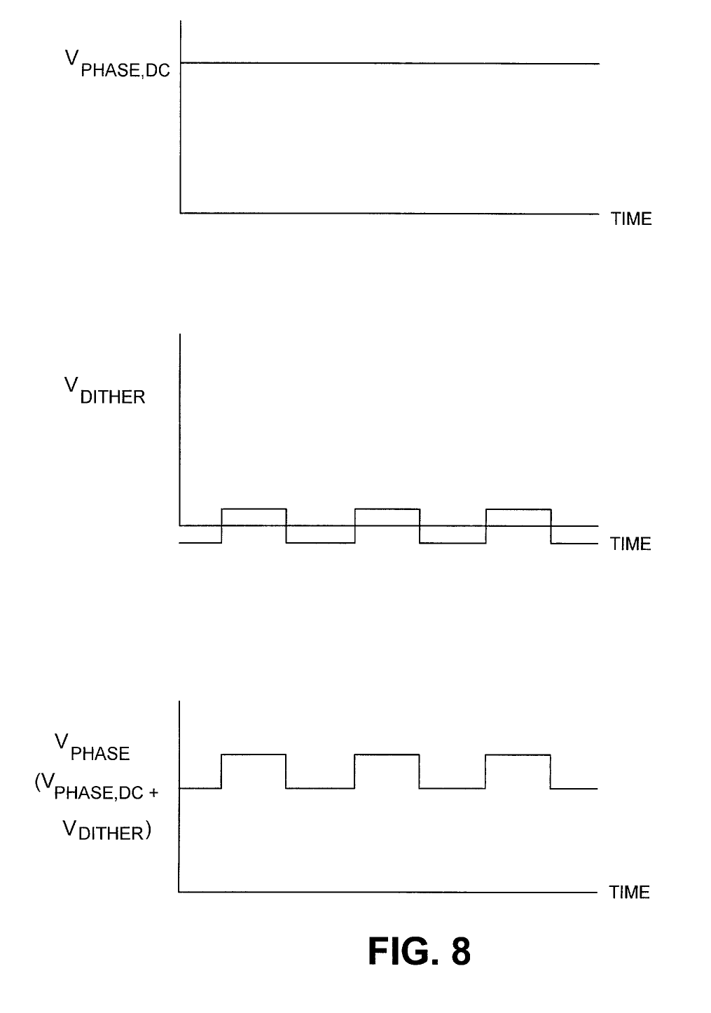

The Microcontroller generates an input signal, Vₚₕₐₛₑ 130, to the electrical Phase Adjust block 120 which is composed of a DC component, V_{phase,Dc} and an AC component, V_{dither}. The resultant Vₚₕₐₛₑ signal may be considered as the V_{phase,DC} component effectively being amplitude modulated by the dither signal (ie. Vₚₕₐₛₑ=V_{phase,DC}+V_{dither}) as shown in FIG. 8. The dither signal could be a single tone having a frequency in the kHz to MHz range or a pseudo-random bit stream (PRBS) sequence in the kbit/s to Mbit/s range. The method used by the microcontroller 140 is independent of the frequency or data rate of the dither but its selection should be chosen so as to minimize any negative impact to the overall fiber optic link performance, which will not be discussed within this invention.

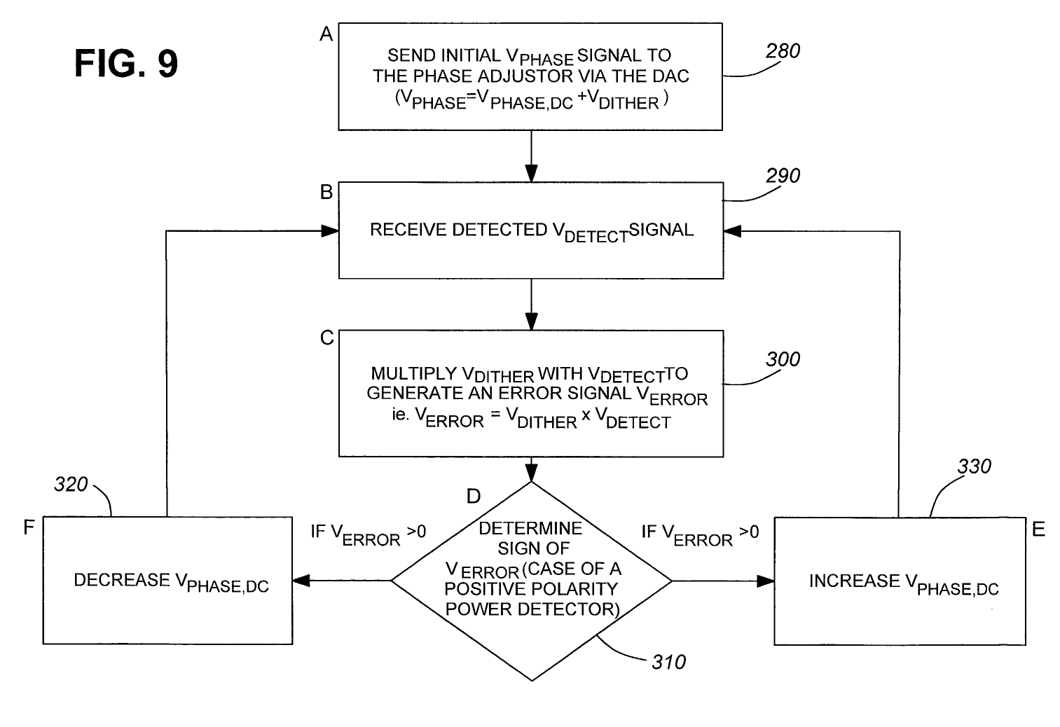

The method to center the optical pulses, Cloch_{optical} 280, and the electrical gating signal, Data_{Electrical}, is illustrated in flowchart of FIG. 9. The Microcontroller applies an initial Vₚₕₐₛₑ signal to the Electrical Phase Adjust block 120 (step 280). The Vₚₕₐₛₑ signal is composed of a DC component and a dither component. After a portion of the main optical transmit signal 190 has been coupled off and converted back into the electrical domain using the photodetector, a power detection is performed on it which yields the receive signal termed V_{detect,raw}. This raw detected signal undergoes appropriate bandpass filtering in order to obtain a signal in the applied dither frequency range. This filtered dither signal is called V_{detect} and is received by the microcontroller (step 290). The microcontroller then multiplies the reference signal, V_{dither} with the received V_{detect} signal in order to generate an error signal Vₑᵣᵣₒᵣ, whose value is given by:

Vₑᵣᵣₒᵣ=V_{dither}×V_{detect}(step 300).

The sign of the error signal, Vₑᵣᵣₒᵣ, is then used to increment or decrement the level of the V_{phase,DC} signal so that the phase adjustor can be steered in the direction of optimal optical pulse to electrical data gate alignment. Step 310 is that of determining the sign of the error signal. If the error signal is positive, the V_{phase,DC} signal is decreased (step 320). If the error signal is negative, the V_{phase,DC} signal is increased (step 330). The case outlined in FIG. 9 assumes a power detector of positive polarity. If a power detector of negative polarity were utilized then the decision would be to decrease V_{phase,DC} instead of increasing it for Vₑᵣᵣₒᵣ>0. As the method approaches the optimal phase setting, the magnitude of the Vₑᵣᵣₒᵣ signal becomes progressively smaller. A point can be reached at which the method will not be able to optimize any further due to other limitations such as receive noise, ADC resolution and phase adjustor precision.

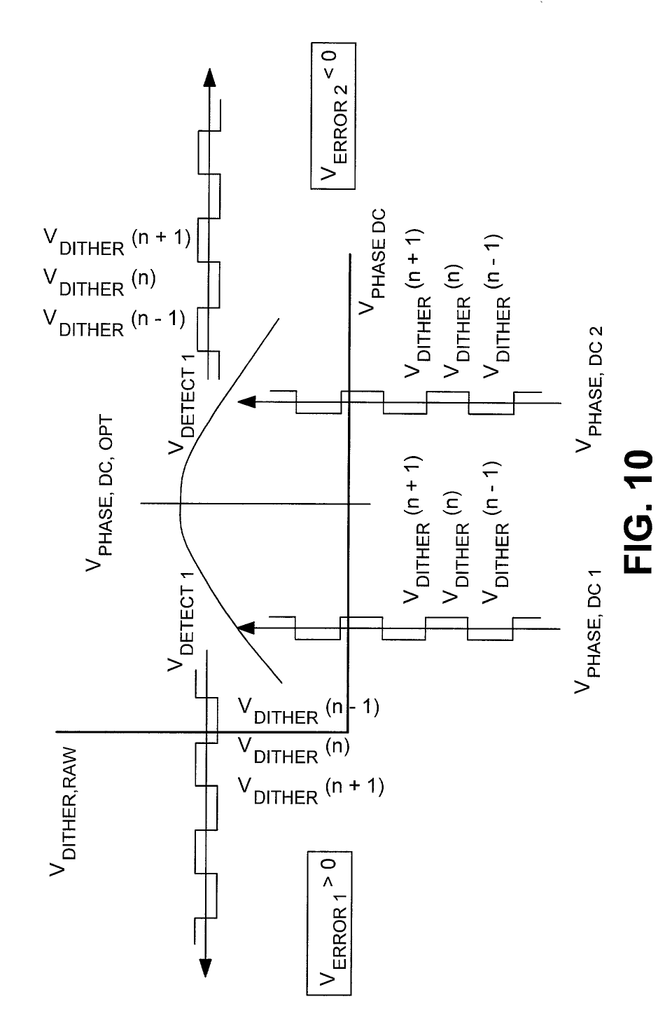

A specific case of this is shown in FIG. 10. When V_{phase,DC} is situated to the left of the optimum setting, V_{phase,DC opt}, as is the case for V_{phase,DC1}, then the generated error signal, Vₑᵣᵣₒᵣ₁, is greater than zero. This positive Vₑᵣᵣₒᵣ causes the Microcontroller to increase V_{phase,DC}, thereby steering the optical pulse phase towards the optimal setting V_{phase,DCopt}. When V_{phase,DC} is situated to the right of the optimum setting, as is the case for V_{phase,DC2}, then the generated error signal, Vₑᵣᵣᵣₒᵣ₂, is less than zero. This negative Vₑᵣᵣₒᵣ value causes the Microcontroller to decreases V_{phase,DC}, thereby again steering the optical phase towards the optimal setting.

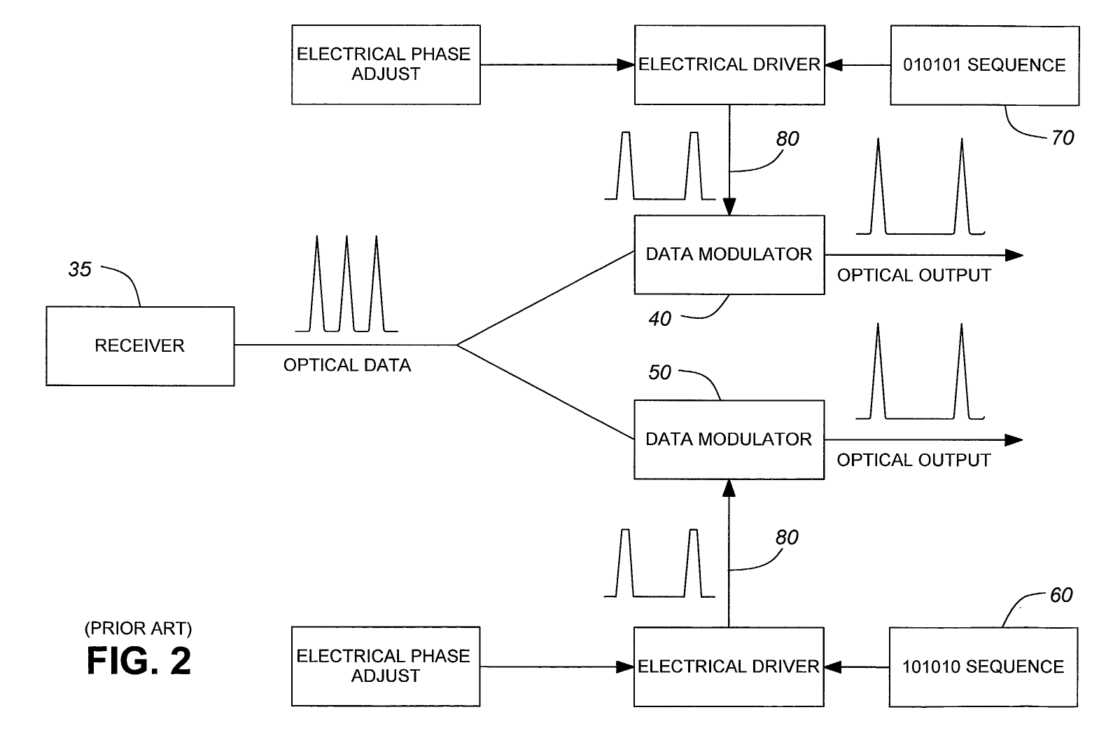

It should be noted that the apparatus and the method described above can be used for applications other than return to zero transmitters. Any applications or devices which require synchronization between an optical pulse stream and an electrical data stream, usually acting as a data gate, can use the above system. One possible application, described in a preceding section, and shown in FIG. 2, is in OTDD receivers. The synchronization between the data modulators and the optical data can be affected and optimized by the above system. In this application, the data modulator (2 modulators in the example illustrated in FIG. 2) can be used to suppress specific bits in the optical data stream.

Another possible application of the above system involves simply monitoring the peak power of an optical pulse stream in a system where the average power is time independent, such as in amplified optical systems.

It should be reiterated that, while current technology makes it more desirable to apply the squaring (or other non linear function) to a portion of the pulse stream converted into an electrical signal, the conversion to an electrical signal is not inherently necessary. The portion of the pulse stream diverted from the main stream may have the nonlinear function directly applied to it. The optical output of this nonlinear function can be used for the same ends as the electrical output of the nonlinear function as described above.

A person understanding the above-described invention may now conceive of alternative designs, using the principles described herein. All such designs which fall within the scope of the claims appended hereto are considered to be part of the present invention.

We claim:

1. A method of synchronizing an optical output with an electrical data gate, said method comprising:
a) converting a fraction of the optical output to an electrical signal;
b) measuring the average power of said electrical signal;
c) adjusting the phase of said optical pulse stream to maximize the average power of said electrical signal.

2. A method as in claim 1 further including the step of applying a non linear function to said electrical signal prior to measuring said average peak power of said electrical signal.

3. A method as in claim 1 further including the step of passing said electrical signal through a high pass filter before executing step b.

4. A method as in claim 1 further including the step of passing said electrical signal through a low pass filter before executing step b).

5. A method as in claim 1 further including the step of applying a dither to a phase adjust signal used to adjust the phase of said optical pulse stream.

6. A method as in claim 4 further including the step of passing said electrical signal through a high pass filter before executing step b.

7. A system for synchronizing the phase of an optical pulse stream with a data stream modulating said pulse stream, said system comprising:
pulse generator means to generate a pulse, said pulse generator means receiving an optical signal, said pulse generator means producing said pulse stream;
optical modulator means for modulating said pulse stream, said optical modulator receiving said pulse stream;
optical tap means for tapping and diverting a portion of said pulse stream;
transformer means for transforming said portion of said pulse stream into an electrical signal, said transformer means receiving said portion of said pulse stream;
power detection means to detect an average power of said electrical signal;
phase adjust means for adjusting a phase of said pulse stream generated by said pulse generator means; and
control means for controlling said phase adjust means based on an average power detected by said power detection means.

8. A system as in claim 7 wherein said optical tap means is an optical coupler.

9. A system as in claim 7 wherein said transformer means is a photodetector.

10. A system as in claim 8 wherein said control means comprises:
an A/D (analog to digital) converter receiving a detected average power signal and producing a digital signal representative of said detected average power signal;
a microcontroller receiving said digital signal and producing a digital phase adjust signal based on the value of said digital signal;
a D/A (digital to analog) converter receiving said digital phase adjust and producing an analog phase adjust signal based on said digital phase adjust signal, said analog phase adjust signal being transmitted to said phase adjust means to adjust said phase of said pulse stream.

11. A system as in claim 7 further including high pass filter means for performing a high pass filtering of said electronic signal prior to said electronic signal being received by said power detection means.

12. A system as in claim 7 further including low pass filter means for performing low pass filtering of said electronic signal prior to said electronic signal being received by said power detection means.

13. A system as in claim 7 further including non linear function means for applying a non linear function to said electronic signal prior to said electronic signal being received by said power detection means.

14. A system as in claim 7 wherein:
said control means includes dither addition means for adding a dither to a detected power signal;
said system includes dither bandpass filter means for filtering a raw detected peak power signal received from said power detection means, said new detected peak power signal being indicative of said peak power of said electrical signal; and
said dither bandpass filter means filters said raw detected peak power signal to produce said detected power signal, said detected power signal being received by said control means and said detected power signal being in the frequency range of said dither.

15. A system as in claim 14 wherein said control means generates an error signal based on said dither and said detected power signal, said error signal determining how said control means controls said phase adjust means.

16. A system as in claim 12 further including high pass filter means for performing a high pass filtering of said electronic signal prior to said electronic signal being received by said power detection means.

17. A method for synchronizing the phase of an output optical pulse stream with an electrical data stream, said method comprising:
a) converting a fraction of output optical pulse stream to an electrical signal;
b) applying a nonlinear function to said electrical signal;
c) measuring an output of said nonlinear function;
d) adjusting the phase of said optical pulse stream to maximize said output of said nonlinear function.

18. A method as in claim 17 wherein said nonlinear function is a squaring function.

19. A method as in claim 17 wherein said method is applied in an optical time division demultiplexing (OTDD) receiver.

20. A method as in claim 17 wherein said method is applied in a return to zero transmitter.

21. A method of monitoring the phase of an optical output relative to an electrical data stream, said method comprising:
a) converting a fraction of optical output to an electrical signal;
b) applying a nonlinear function to said electrical signal; and
c) measuring an output of said nonlinear function.

22. A method as in claim 21 wherein said nonlinear function is a squaring function.

23. A method as in claim 21 wherein said method is applied in an optical time division demultiplexing (OTDD) receiver.

24. A method as in claim 21 wherein said method is applied in a return to zero transmitter.

25. A method for synchronizing the phase of an optical output with an electrical data stream, said method comprising:
a) applying a nonlinear function to a portion of the optical output;
b) measuring an output of said non linear function; and
c) adjusting the phase of said optical pulse stream to maximize said output of said nonlinear function.

26. A method as in claim 25 wherein said nonlinear function is a squaring function.

27. A method as in claim 25 wherein said method is applied in an optical time division demultiplexing (OTDD) receiver.

28. A method as in claim 25 wherein said method is applied in a return to zero transmitter.

29. A method of monitoring the phase of an optical output relative to an electrical data stream, said method comprising:
a) applying a nonlinear function to a portion of the optical output; and
b) measuring an output of said non linear function.

30. A method as in claim 29 wherein said nonlinear function is a squaring function.

31. A method as in claim 29 wherein said method is applied in an optical time division demultiplexing (OTDD) receiver.

32. A method as in claim 29 wherein said method is applied in a return to zero transmitter.

33. A method of monitoring the peak power of an optical pulse stream in a system where the average optical power is constant, said method comprising:
a) applying a squaring function to a signal chosen from a group comprising:
said optical pulse stream;
an electrical signal derived from said optical pulse stream,
b) measuring an output of said nonlinear function.
